(19) United States
(12) Patent Application Publication
(10) Pub. No.: US 2006/0108418 A1
(43) Pub. Date: May 25, 2006

(54) System for buying and selling tickets to sporting events in the aftermarket through gifting

(76) Inventor: Rodney S. Rice, Boerne, TX (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(21) Appl. No.: 11/285,867

(22) Filed: Nov. 22, 2005

Related U.S. Application Data
(60) Provisional application No. 60/630,526, filed on Nov. 22, 2004.

(51) Int. Cl. G06K 5/00

(52) U.S. Cl. 235/382

(57) ABSTRACT

Embodiments of the present invention provide a computerized system for forming a network of aftermarket sellers and buyers of sporting tickets which allows for the convenient and safe resale of such tickets and the generation of donations to the respective venues foundations and designated charities via a portion of the resale proceeds through at least one central processing unit, storage means containing the identification of buyers and sellers, means for buyers to query what tickets are available for sale, means for sellers to list tickets for sale and set parameters for such sale, and means for such system to monitor activity of buyers to ensure the buyers are permitted buyers and that tickets are being sold on a distributed basis for the end use by the prospective buyers.

### CROSS-REFERENCE TO RELATED APPLICATIONS

The present application claims the benefit of U.S. Provisional Patent Application No. 60/630,526, entitled “System for Buying and Selling Tickets to Sporting Events in the After-market Through Gifting,” and filed on Nov. 22, 2004. The aforementioned application is hereby incorporated by reference herein in its entirety for all purposes.

### BACKGROUND OF THE INVENTION

1. Field

The present invention relates generally to a system for selling unused sporting tickets in the aftermarket, and more particularly to a system and methods for buying and selling sporting tickets in the aftermarket by utilizing a system which allows for all or a portion of the ticket resale proceeds to be directed as a charitable donation.

2. Description of Related Art

Being a season ticket holder to sporting events (and other forms of arts and entertainment) is a very costly endeavor largely limited to wealthy individuals and/or fanatics. Typically season ticket holders can not go to every event for which they have paid and the means for re-selling or giving away unused tickets has been limited and cumbersome heretofore. A very sizable aftermarket has developed fueled by scalpers and ticket brokers who buy tickets and then sell them to aftermarket buyers typically outside the venue just prior to the event, on auction websites during the days and weeks preceding the event or via advertising of tickets via various online and offline marketing mediums. The reality of the current market environment does not provide season ticket holders with a convenient way for dispensing of tickets they can not use and many times results in a significant amount of the resale value of the ticket ending up in the pockets of professional scalpers and/or ticket brokers at the expense of the season ticket holder and/or the venue owner or its beneficiaries (e.g. a football team's University Endowment or the NCAA system as a whole).

Therefore, there is a need in the art for improved systems and methods for selling tickets which can not be utilized by the original ticket holder in the aftermarket which is safer and more convenient for the season ticket holder and such that the value of the ticket remains with the original ticket holder, the venue owner or their endowment, designated charities and or beneficiaries.

### BRIEF SUMMARY OF THE INVENTION

Embodiments of the present invention relate generally to a system for selling unused sporting tickets in an aftermarket, and more particularly to a system and methods for selling unused sporting tickets and utilizing such system to create charitable donations from all or a portion of the ticket resale proceeds for the venue owner or other directed charities and/or beneficiaries. According to some embodiments, the ticket resale and gifting system allows for the safe and convenient resale of season tickets by the season ticket holder and the garnering of donations by the venue owner and its endowment, beneficiaries, or other designated charities as directed by the venue owner and/or season ticket holder. Embodiments of the present invention provide for the efficient resale of tickets via a computerized system in which buyers and sellers consummate the resale of tickets via one or more system access points (e.g. an email client, a website, wireless web, a fax, a phone, cell text client, a text messaging client and/or an interactive voice response unit or prompter).

Some embodiments of the system enable season ticket holders to receive tickets which are not scanned upon entry into the venue and thus require such tickets be mailed back to the venue with the venue then disseminating the ticket to the resale purchaser or destroying and replacing such ticket. Other embodiments of the system enable the season ticket holder to receive tickets which are scanned upon entry into the venue and such embodiment allows for the electronic voiding of the original ticket upon the resale of the corresponding seat and allows for re-ticketing and re-issuance of new tickets to the resale purchaser or allows such resale purchaser to enter the venue via the scan of a credit card or driver's license at the venue entry or the entry of a pass code as provided by the system at the time of purchase. In the case of re-ticketing, the system may print a personally-identifiable alpha-numeric code on the ticket for the purpose of linking the actual purchaser to the re-sold ticket (e.g. driver's license number of after-market buyer). In such embodiments whereby the season ticket holders have tickets which are not scanned upon entry, the season ticket holder may receive a pre-addressed envelope with his or her season tickets allowing for the return of those tickets which are not going to be utilized by such season ticket holder to the venue. In some embodiments, the season ticket holder may put the unused tickets up for sale via the system in an auction format to all permitted buyers. In another embodiment, the season ticket holder may put up for sale the unused tickets for a fixed, defined price to all permitted buyers. In yet another embodiment, the season ticket holder may sell the unused tickets via the system to a specified buyer for a specified price. In all such embodiments, the seller may specify the amount (in accordance with the limitations set by the venue owner) of the resale proceeds to be kept by the seller and the amount he or she wishes to donate to the venue owner, its endowment, its beneficiaries or other permitted charities. In the case of auctioned tickets, the season ticket holder may determine how to apportion the proceeds following the conclusion of the auction when the total auction proceeds are known. One embodiment of the system allows permitted aftermarket buyers to purchase a specific ticket or group of tickets for a fixed price on a “first-come, first-served” basis.

In another embodiment of the system, the system allows for buyers to bid on a specific ticket or group of tickets during a defined auction period with the highest bidder winning such tickets at the conclusion of the auction. In yet another embodiment of the system, buyers are allowed to put in their seating preference or a series of seating preferences via the entry of sections and a seating row or range of rows or by selecting pre-defined zones of seats with maximum prices indicated for each of the seating preference(s). In such embodiment, the system may optimize which ticket or group of tickets to sell to the buyer based on the buyer's ranking of preferences and maximum prices and consummate such transaction or provide the buyer with ranked results of such prioritized query such that the buyer can decide which ticket or group of tickets to purchase. One embodiment of the system allows the venue owner to prescribe the maximum amount of the resale ticket proceeds which may be kept by the season ticket holder. The amount may be input as a percent of the resale proceeds, as a percent of the amount originally paid for the ticket being resold or set as a fixed dollar amount. Another embodiment allows the venue owner to set a maximum price for which tickets can be sold, such maximum being expressed, for example, in actual dollars or a percentage of face value and corresponding to the amount the original purchaser paid for such ticket. The venue owner may also determine whether the resale ticket proceeds permitted to be retained by the season ticket holder are to be distributed back to the season ticket holder in cash (or cash-like form) or whether such amounts are to be issued as credits against future ticket purchases. Following the conclusion of a ticket resale via the system, the system may send the seller a communication via one or more of the system access points with a summary of the transaction including the proceeds generated, the amount being remitted back to the seller, and the amount being donated, for example. The system may also send the buyer of the resold tickets via one or more system access points a confirmation of purchase and may include a pass code to be used when picking up such tickets at the venue or otherwise to authenticate such buyer's rights to the seats which have been purchased. Such pass code may include one or more numbers unique to the buyer (e.g. driver's license number) and/or an additional series of alpha-numeric characters, the pass code serving to authenticate the rightful buyer in receiving the tickets and to prohibit abuse of the system by commercial buyers (i.e. buyers purchasing more tickets than they intend for their own personal use).

According to some embodiments of the present invention, the venue owner may, via a system access point, set a maximum number of tickets which can be purchased by an individual and control such maximum with the aforementioned use of the pass code. The system or certain venue owners may block individuals from using the system in the event they have abused the system (e.g. defaulted on payment, circumvented the maximum tickets purchased limit, etc). In one embodiment of the system, the venue owner distributes the re-sold tickets via a manual will call system in which buyers go to an on-site location, provide proof of identity to a venue attendant and are given the tickets by the attendant. In another embodiment, an automated ticket dispensing system is utilized whereby buyers are able to insert a driver's license and/or credit card into such machine with the machine dispensing the tickets upon successful verification. Such machine may use, for example, retinal scans, fingerprint verification, and/or other similar security-related technologies to authenticate a buyer. In the case of venues utilizing ticket scanners at the entry points, the prior steps may be skipped with the buyers providing a driver's license and/or credit card to the gate attendants and in return receiving entry into the venue or pass through automated authentication entry points utilizing one or more of the aforementioned physical verification technologies. In one embodiment of the system, in the case of venues with ticket scanning, the buyer may also be permitted to print its ticket or proof of ticket ownership directly via the system. In another embodiment of the invention, the venue may have a paperless ticketing system and in such case the season ticket holder may sell his or her seat(s) via the system with such buyer assuming the right to such seat(s) with the entry into the venue and verification of the right to such seat(s) for a particular event being verified by one or more of the following: driver's license, credit card, and/or unique pass code generated in conjunction with the purchase by the aftermarket buyer.

According to some embodiments of the present invention, methods for facilitating charitable giving by ticket resale are provided. Such embodiments of methods include listing one or more tickets for sale by a seller via an aftermarket ticket resale system, designating a beneficiary other than the seller to receive a specified percentage of a sale price of the one or more tickets, collecting payment for the one or more tickets, and transferring at least a portion of the payment to the beneficiary. Such embodiments may further include, for example, transferring another portion of the payment to the seller.

Methods for ticket resale are provided according to some embodiments of the present invention. Such embodiments include receiving ticket information via a network from a seller for an available event ticket, the ticket information including identification of an event, a designation of one or more beneficiaries other than the seller, and a sales method. Such embodiments of methods may further include listing the available event ticket as available for sale according to the sales method, receiving payment of a sale price for the available ticket, where the sale price is determined by the sales method, and initiating a transfer of at least a portion of the payment to the one or more beneficiaries. In some cases, the ticket information may further include an indication of a percentage of the sale price dedicated to the one or more beneficiaries, in which cases initiating the transfer of at least the portion of the payment to the one or more beneficiaries may include initiating a transfer of the percentage of the sale price to the one or more beneficiaries. In other cases, the ticket information may further include an indication of an amount of the sale price dedicated to the one or more beneficiaries, in which cases initiating the transfer of at least the portion of the payment to the one or more beneficiaries may include initiating a transfer of the amount to the one or more beneficiaries.

Such embodiments of methods may further include sending a transaction record to the seller which indicates the sale price, the payment, the portion of the payment, and/or the one or more beneficiaries. According to some instances of the embodiments, receiving payment of the sale price includes receiving payment of the sale price from a buyer, and embodiments of the methods further include sending a transaction record to the buyer which indicates the sale price and the payment. Other instances of the embodiments may include initiating a transfer of some or all of the remaining payment to the seller. In some cases, receiving the ticket information includes sending a list of the seller's currently held tickets to the seller and receiving the seller's selections from the list of the seller's currently held tickets to sell. In other cases, the sales method used to sell the tickets may include, but is not limited to, an auction, a minimum bid auction, a fixed price sale, a fixed price sale to the public, and/or a fixed price sale to a specified buyer.

In some instances of the embodiments, the sales method is an auction and the sales price is determined by bidding. In other instances, the sales method is a fixed price sale to a specified buyer; in such instances, the ticket information further includes identification of the specified buyer. In yet other instances, the sales method is a fixed price sale, in which the sales price is determined by the seller. Some embodiments of methods according to the present invention include receiving payment source information from a buyer, verifying that the payment source is sufficient to satisfy the sale price, and debiting the payment source for an amount equal to the payment.

According to some embodiments of the methods, the methods further include generating a pass code for use to gain entry to the event. In cases where payment of the sale price is received from a buyer, the methods may further include collecting personally-identifiable information of the buyer and incorporating at least a portion of it into the pass code. In some cases, the methods may further include generating a new ticket for the buyer which includes the pass code, and/or printing a new ticket.

According to embodiments of the present invention, systems for ticket resale are provided. Such systems may include a computer communicably coupled to a computer readable medium and a network, and the computer readable medium may include instructions executable by the computer to receive ticket information via a network from a seller for an available event ticket, the ticket information including an event identification, a designation of one or more beneficiaries other than the seller, and a sales method; list the available event ticket as available for sale according to the sales method; receive payment of a sale price for the available ticket, the sale price determined by the sales method; and initiate a transfer of at least a portion of the payment to the one or more beneficiaries.

This summary provides only a general outline of some embodiments of the present invention. Many other objects, features, advantages and other embodiments of the present invention will become more fully apparent from the following detailed description, the appended claims and the accompanying drawings.

### BRIEF DESCRIPTION OF THE SEVERAL VIEWS OF THE DRAWING

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 illustrates a system for buying and selling sporting tickets in the aftermarket according to embodiments of the present invention.

FIG. 2 illustrates a flow diagram depicting methods for buying tickets in the aftermarket, according to various embodiments of the present invention.

FIG. 3 illustrates a flow diagram depicting methods for selling tickets in the aftermarket, according to various embodiments of the present invention.

FIG. 4 illustrates an exemplary computer system according to embodiments of the present invention.

FIG. 5 illustrates a flow diagram depicting methods for resale of tickets according to embodiments of the present invention.

FIG. 6 illustrates a flow diagram depicting methods for ticket resale according to various embodiments of the present invention.

### DETAILED DESCRIPTION OF THE INVENTION

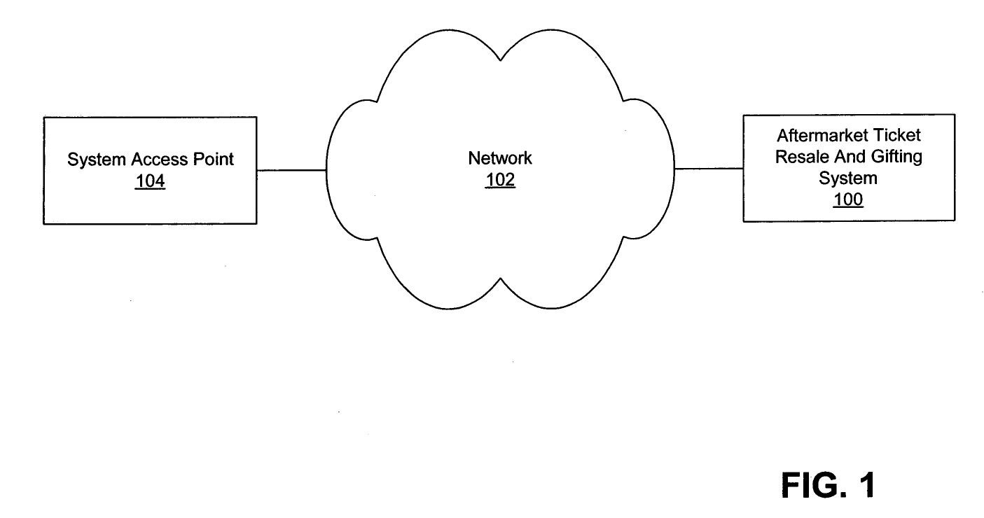

According to embodiments of the present invention, season ticket holders may subscribe to membership with a ticket resale system, and in doing so may sell their tickets to permitted aftermarket buyers. FIG. 1 illustrates one example of a ticket resale system according to embodiments of the present invention. An aftermarket ticket resale and gifting system (“ATRAGS”) 100 is communicably coupled to a network 102. A system access point (“SAP”) is also communicably coupled to network 104. ATRAGS 100 and/or SAP 104 may be implemented as a computer system 500, for example. According to some embodiments of the present invention, users of ATRAGS 100 may access ATRAGS 100 through SAP 104. As used herein, the term season ticket holder is used in its broadest sense, and is used to refer to any person or entity holding tickets to any venue for the purposes of viewing sports, arts and entertainment including, for example, but not limited to, football, basketball, baseball, hockey, ballet, opera, concerts, or other such entertainment-related venues.

Some embodiments of the present invention provide systems and methods for reselling tickets to sporting events in an aftermarket through a network. Such systems and methods can be implemented using computers and computer software. Such computer software can be maintained on a computer readable medium. As used herein, the term “computer readable medium” is used in its broadest sense to mean any storage device accessible to a computer. Thus, for example, a computer readable medium can be a hard disk drive, a RAM, a floppy diskette, a CD ROM, an EEPROM, a magnetic tape, and/or the like. In some cases, the computers and/or computer software can communicate via a network. In particular, the computers can be communicably coupled to a network and/or each other. As used herein, the term “network” is used in its broadest sense to mean any system capable of passing communications from one entity to another. Thus, for example, a network can be, but is not limited to, the Internet, a virtual private network, a local area network, a wide area network, a WiFi network, a PSTN, a cellular network, and/or any combination thereof. Further, the term “communicably coupled” is used herein in its broadest sense to mean any coupling whereby information may be passed. Thus, for example, communicably coupled includes electrically coupled by, for example, a wire; optically coupled by, for example, an optical cable; and/or wirelessly coupled by, for example, a radio frequency or other transmission media. In addition, the term “ticket” is used herein in its broadest sense to mean any record, whether printed, electronic, or otherwise, granting access to an event.

A SAP 104 may be, for example, an email client, a website, wireless web, a fax, a phone, cell text client, a text messaging client and/or an interactive voice response unit or prompter. Ticket sellers may list, via SAPs 104, tickets for sale and indicate method of sale (e.g. directed private, fixed price public or public auction) and indicate the amount of the proceeds he or she wishes donate to the venue and its endowment, beneficiaries or other permitted charities. Ticket sellers and/or buyers may interact with ATRAGS 100 via SAP 104, such as, for example, via a web browser interface over network 102 which may permit entry or input of data via text boxes, radio buttons, check boxes, and/or links, for example, and which may permit display of data via text and graphics, for example.

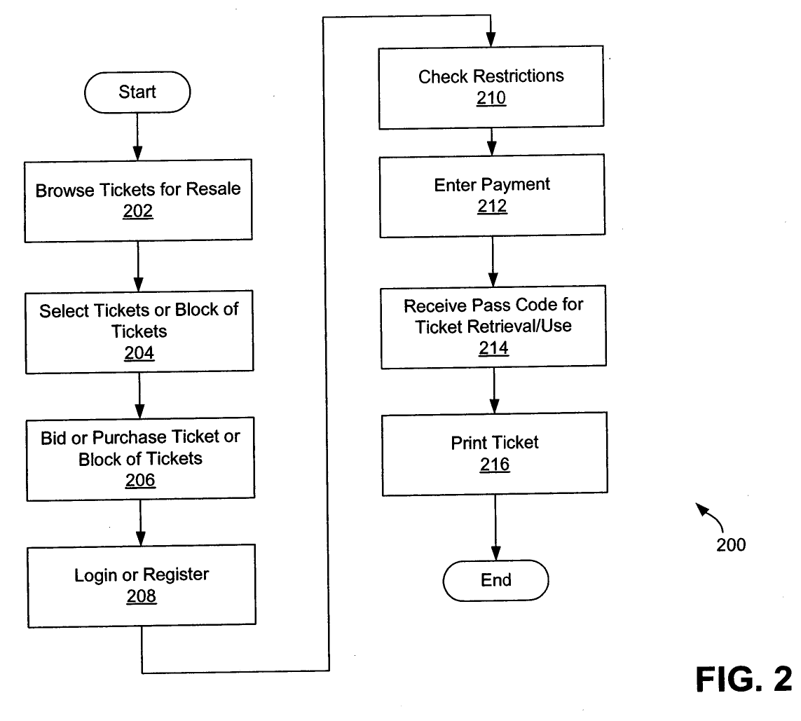

FIG. 2 illustrates an exemplary flow diagram 200 depicting methods for buying tickets in the aftermarket, according to various embodiments of the present invention. A user of the system 100, such as a ticket buyer, may browse tickets for resale (block 202). A ticket or block of tickets may be selected (block 204), such as, for example, by choosing a ticket(s) from a browsed list, by entering a section, row and seat number sequence or range, or by searching for a ticket based on supplied criteria. The participating buyer next enters a bid amount in the case of an auction or checks a box to purchase a ticket or block of tickets in the event the ticket(s) is being sold at fixed price (block 206), and then enters the buyer's information; alternatively, the buyer's information may have already been provided during login to system 100 (block 208). Such entered information may include, but is not limited to, name, date of birth, driver's license number, credit card number, phone number and/or social security number.

Next, restrictions may be checked to determine if the particular buyer is permitted to access the particular venue's resale system, ticket or block or tickets (block 210). For example, the buyer's information may be checked against all other purchase records to verify the buyer has not exceeded the maximum seats purchased per game limitation or otherwise been banned from use of the system due to such violations historically or other issues like defaulting on payment. Next, the participating buyer may enter payment (block 212), such as by entering credit card or debit account information, for example. In return, the buyer may then receive pass code information (block 214). Such pass code information may include, for example, a series of alpha-numeric characters including some which are tied to the buyer's personally-identifiable information (e.g. drivers license, social security number, passport number, etc.) and others which tie to the specific transaction (e.g. rights to a specific seat within a particular venue on a date certain). In some cases, the buyer may be able to print the ticket via system 100 (block 216).

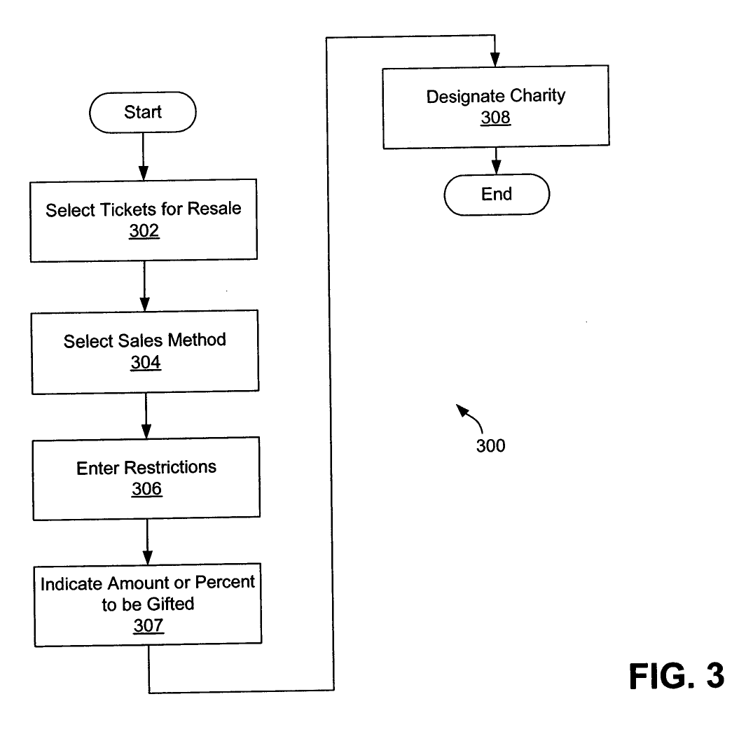

FIG. 3 illustrates an exemplary flow diagram 300 depicting methods for listing tickets for resale, according to various embodiments of the present invention. A participating ticket holder may list tickets for resale by, for example, selecting them from a list of tickets known to be held by such ticket holder by system 100 (block 302). Alternatively, the participating ticket holder may list tickets for resale by, for example, entering information about the tickets into system 100. Such ticket information includes, but is not limited to, name and date of event, name of venue, ticket price, ticket restrictions, ticket purchase value, section number, row number, and/or seat number. The seller may also select the method of sale (e.g. directed private, fixed price public or public auction) (block 304). Next, the ticket holder may enter any restrictions for the sale of such tickets (e.g. minimum price in the auction format or the price to be sold in the fixed price format) (block 306) within the limitations set by the venue, if any. The seller may also indicate the dollar amount or percent of proceeds to be donated to the venue's beneficiary or approved charity (block 307) within the limitations set by the venue, if any. The seller may also select the entity to which the donated proceeds will go in the event the venue has approved more than one endowment, charity or beneficiary (block 308).

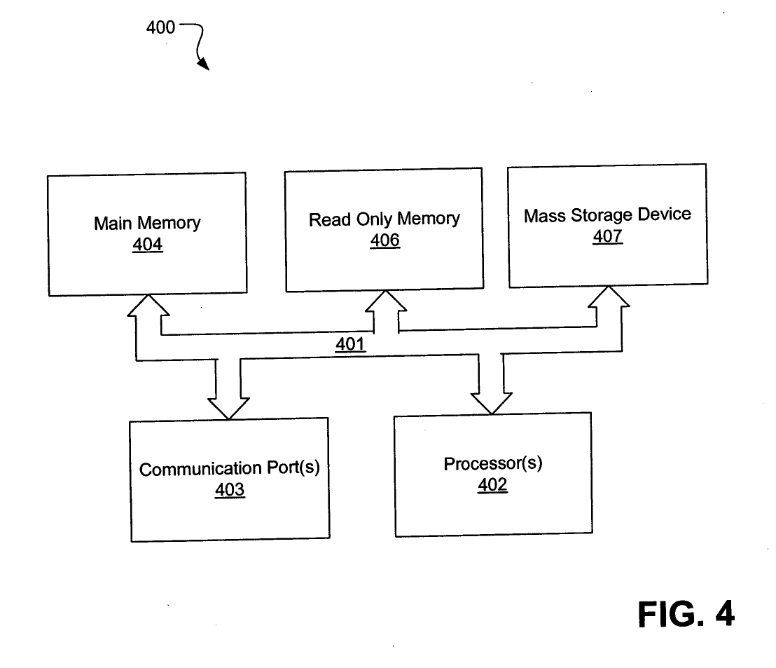

FIG. 4 is an example of a computer system 400 with which embodiments of the present invention may be utilized. Computer system 400 represents an exemplary system access point 104 and/or ATRAGS 100 which may implement one or more of the methods discussed herein for facilitating buying and selling of tickets in the aftermarket. In this simplified example, the computer system 400 comprises a bus 401 or other communication means for communicating data and control information, and one or more processing devices 402, such as a well known processor, Application Specific Integrated Circuit (ASIC), a field programmable gate array (FPGA), or the like, coupled with bus 401.

In this simplified embodiment, computer system 400 further comprises a random access memory (RAM) or other dynamic storage device (referred to as main memory 404), coupled to bus 401 for storing information and instructions to be executed by processing device 402. Main memory 404 also may be used for storing temporary variables or other intermediate information during execution of instructions by processor(s) 402.

Computer system 400 can also include a read only memory (ROM) 406 and/or other static storage device coupled to bus 401 for storing static information and instructions for processing device 402. A mass storage device 407, such as a magnetic disk or optical disc and its corresponding drive, may also be coupled to bus 401 for storing instructions and information, such as configuration files, a key store and registration database, etc. Such ROM 406 may comprise, for example, one or more databases in which information may be stored and/or retrieved, such as, for example, information received or sent via system 100 or SAP 104.

One or more communication ports 403 may also be coupled to bus 401 for supporting network connections and communication of information to/from the computer system 400 by way of a communication network, such as a Local Area Network (LAN), Wide Area Network (WAN), or the Internet, for example. The communication ports 403 may include various combinations of well-known interfaces, such as one or more modems to provide network access, one or more 10/100 Ethernet ports, one or more Gigabit Ethernet ports (fiber and/or copper), or other well-known network interfaces commonly used in internetwork environments. In any event, in this manner, the computer system 400 may be coupled to a number of other network devices, communication devices, clients, NTMs, and/or servers via a conventional communication network infrastructure.

Optionally, operator and administrative interfaces (not shown), such as a display, keyboard, and a cursor control device, may also be coupled to bus 401 to support direct operator interaction with computer system 400. Other operator and administrative interfaces can be provided through network connections connected through communication ports 403.

Finally, removable storage media (not shown), such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), Zip disks, or USB memory devices, e.g., thumb drives or flash cards, may be coupled to bus 401 via corresponding drives, ports or slots.

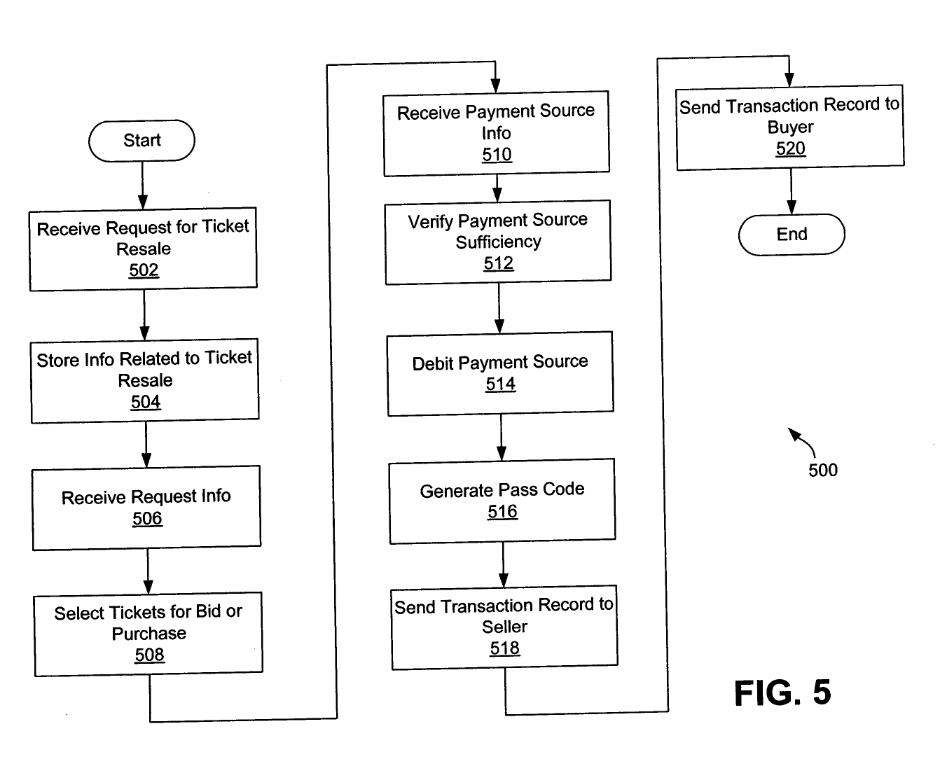

FIG. 5 illustrates a flow diagram 500 depicting methods for reselling sporting tickets in the aftermarket through gifting according to embodiments of the present invention. Ticket information may be received via a network for an available ticket associated with a particular seller (block 502). Such ticket information may include, for example, how such ticket is to be sold, at what minimum or fixed price the ticket is to be sold, and how the proceeds of the sale are to be directed between the seller and the venue's endowment, beneficiaries and/or approved charities. The ticket information may be stored, for example, in a database containing information about several tickets for sale (block 504). Such a database may be, for example, a collection of information stored in ROM 406 or mass storage device 407 and accessible by processor 402 of system 100, for example. Request information may be received via the network for a desired ticket(s) (block 506). Such request information may include an identification of the desired ticket such as, for example, the section, row and seat number associated with such ticket or block of tickets, the minimum or maximum price or fixed price at which they are being offered for sale, and/or the name or date of the ticketed event.

Tickets may be selected for purchase or bid (block 508). The user can optionally enter payment information into the system (block 510) provided such information is not on file with the user's membership profile. In the event such information is on file, the user may be prompted to confirm use of a particular payment method and such method(s), whether on file or entered ad hoc, may be verified for sufficiency of funds (block 512) and such funds may be debited (block 514). Once such transaction has been made and paid for the seller may receive the unique pass code for acquisition or use of such tickets (block 516). Following the consummation of a ticket resale, the system may transmit a transaction record (block 518) via one or more system access points to the seller indicating the proceeds from such sale and where such proceeds have been credited (e.g. sellers bank account or credit card, venue's endowment, beneficiary or designated charity). In addition, the system may also disseminate purchase verification via one or more system access points to the buyer (block 520) including a pass code to the extent applicable or necessary for use of the purchased tickets.

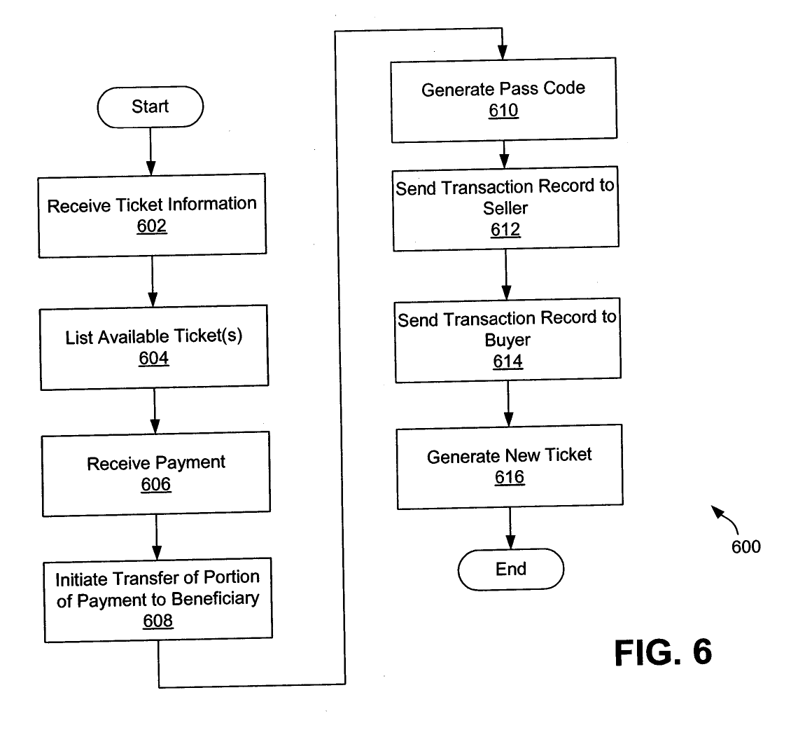

FIG. 6 illustrates a flow diagram 600 depicting methods for ticket resale according to various embodiments of the present invention. According to such embodiments, ticket information is received via a network from a seller for an available event ticket (block 602). Such ticket information may include, but is not limited to, identification of an event, a designation of one or more beneficiaries, endowments, and/or charities to which a percentage of the ticket resale proceeds may be donated, and a sales method. The beneficiary would typically be someone other than the seller, according to embodiments of the present invention. The sales method may be, for example, an auction, a minimum bid auction, a fixed price sale, a fixed price sale to the public, and/or a fixed price sale to a specified buyer. According to some embodiments of the present invention, system 100 already knows which tickets the seller holds based on login or other such information provided by the seller to system 100; according to one example of how the ticket information may be provided, the seller may be provided with a checkbox or radio button list of available tickets to sell, from which the seller may choose. Next, available event tickets may be listed as available for sale according to the sales method (block 604). For example, if the sales method is an auction, the ticket or tickets may be put up for auction or listed as available for bidding offers, and the sale price may be determined as the highest bid price. Such listing may be accomplished, for example, via a web browser interface. Next, payment of the sale price may be received (block 606). Once payment has been received, a transfer of at least a portion of the payment may be initiated in favor of one or more of the beneficiaries (block 608). According to some embodiments of the present invention, one or more beneficiaries may be designated by the seller; according to other embodiments, each venue and/or system 100 may provide a predefined set of beneficiaries, endowments, and/or charities from which the seller and/or the buyer may choose to which a portion or all of the ticket sale proceeds may be transferred.

Upon completion of the transaction, a pass code may be generated (block 610). The pass code may include personally-identifiable information collected from the buyer such as, for example, some or all of the buyer's driver's license number. According to some embodiments of the present invention, the pass code may be required for entrance, either instead of the ticket or in addition to the ticket, in order to authenticate the identity of the buyer during purchase and/or use, and to prevent buyers from commercial scalping or otherwise buying more than the individual ticket purchase allotment as determined by the venue, the system 100 administrator, and/or an other ticket controlling entity. In some embodiments, a new ticket may be generated (block 616), and such new ticket may display the pass code. The new ticket may be printed, for example, along with the pass code. According to some embodiments of the present invention, once the ticket resale and gifting transaction has been completed, a transaction record may be sent to the seller (block 612), such transaction record indicating the sale price, the payment, the identity of the one or more beneficiaries, the identity of the buyer, and/or the amount or percentage transferred to the one or more beneficiaries. According to other embodiments of the present invention, once the ticket resale and gifting transaction has been completed, a transaction record may be sent to the buyer (block 614), such transaction record indicating the sale price and/or the payment, for example.

According to some embodiments of the present invention, system 100 may be owned, operated, administrated, and/or controlled by an owner of a particular venue, and the ticket “resale” of such system 100 may focus exclusively on tickets for events at the particular venue, and/or for events over which the system 100 administrator has control. According to such embodiments, ticket information may be received (block 602) by simply identifying the seller, or receiving identifying information of the seller, to match up with the system 100 administrator's records about which tickets the seller holds; alternatively, ticket information may be received via the input by the seller of unique ticket-identifying information. Listing available tickets (block 604) would include, according to such embodiments, listing available tickets for which the venue owner or event controller is willing to buy back, refund or allow the return of the available ticket from the seller and sell a new corresponding ticket to the buyer. Such a transaction could be achieved, for example, by allowing the buyer to use the seller's ticket along with a supplemental pass code to gain entry to the event, or by canceling the seller's ticket and issuing a new ticket to the buyer. According to such embodiments, any profit achieved in the transaction above the face value of the seller's ticket could be divided between any or all of the seller, the venue owner or event controller, and the beneficiary. In some embodiments, all profit achieved above the seller's ticket's face value could be directed to the beneficiary, endowment, or charity. Such embodiments of systems and methods in which the buyback and resell ticket transaction passes through the ticket issuer or event controller may facilitate compliance with various laws regarding ticket transactions. Various other modifications are possible to systems and methods of the present invention for customizing such systems and methods for use in various other contexts.

Embodiments of the invention have now been described in detail for purposes of clarity and understanding. However, it will be appreciated that certain changes and modifications may be practiced within the scope of the appended claims. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A method for facilitating charitable giving by ticket resale, the method comprising:
listing one or more tickets for sale by a seller via an aftermarket ticket resale system;
designating a beneficiary other than the seller to receive a specified percentage of a sale price of the one or more tickets;
collecting payment for the one or more tickets; and
transferring at least a portion of the payment to the beneficiary.

2. The method of claim 1, further comprising:
transferring another portion of the payment to the seller.

3. A method for ticket resale, the method comprising:
receiving ticket information via a network from a seller for an available event ticket, the ticket information including identification of an event, a designation of one or more beneficiaries other than the seller, and a sales method;
listing the available event ticket as available for sale according to the sales method;
receiving payment of a sale price for the available ticket, the sale price determined by the sales method; and
initiating a transfer of at least a portion of the payment to the one or more beneficiaries.

4. The method of claim 3, wherein the ticket information further includes an indication of a percentage of the sale price dedicated to the one or more beneficiaries, and wherein initiating the transfer of at least the portion of the payment to the one or more beneficiaries comprises initiating a transfer of the percentage of the sale price to the one or more beneficiaries.

5. The method of claim 3, wherein the ticket information further includes an indication of an amount of the sale price dedicated to the one or more beneficiaries, and wherein initiating the transfer of at least the portion of the payment to the one or more beneficiaries comprises initiating a transfer of the amount to the one or more beneficiaries.

6. The method of claim 3, further comprising:
sending a transaction record to the seller, the transaction record indicating the sale price.

7. The method of claim 6, the transaction record further indicating the payment, the portion of the payment, and the one or more beneficiaries.

8. The method of claim 3, wherein receiving payment of the sale price comprises receiving payment of the sale price from a buyer, the method further comprising:
sending a transaction record to the buyer, the transaction record indicating the sale price and the payment.

9. The method of claim 3, wherein receiving the ticket information comprises sending a list of the seller's currently held tickets to the seller and receiving the seller's selections from the list of the seller's currently held tickets to sell.

10. The method of claim 3, wherein the sales method is selected from the group consisting of: an auction, a minimum bid auction, a fixed price sale, a fixed price sale to the public, and a fixed price sale to a specified buyer.

11. The method of claim 3, wherein the transfer is a first transfer, and wherein the portion is a first portion, the method further comprising:
initiating a second transfer of at least a second portion of the payment to the seller.

12. The method of claim 3, wherein the sales method is an auction, and wherein the sales price is determined by bidding.

13. The method of claim 3, wherein the sales method is a fixed price sale to a specified buyer, and wherein the ticket information further includes identification of the specified buyer.

14. The method of claim 3, wherein the sales method is a fixed price sale, and wherein the sales price is determined by the seller.

15. The method of claim 3, further comprising:
receiving payment source information from a buyer;
verifying that the payment source is sufficient to satisfy the sale price; and
debiting the payment source for an amount equal to the payment.

16. The method of claim 3, further comprising:
generating a pass code for use to gain entry to the event.

17. The method of claim 16, wherein receiving payment of the sale price comprises receiving payment of the sale price from a buyer, the method further comprising:
collecting personally-identifiable information of the buyer; and
incorporating at least a portion of the personally-identifiable information into the pass code.

18. The method of claim 17, further comprising:
generating a new ticket for the buyer, the new ticket including the pass code.

19. The method of claim 18, further comprising:
printing the new ticket.

20. A system for ticket resale, the system comprising:
a computer, wherein the computer is communicably coupled to a computer readable medium and a network, and wherein the computer readable medium includes instructions executable by the computer to:
receive ticket information via a network from a seller for an available event ticket, the ticket information including an event identification, a designation of one or more beneficiaries other than the seller, and a sales method;
list the available event ticket as available for sale according to the sales method;
receive payment of a sale price for the available ticket, the sale price determined by the sales method; and
initiate a transfer of at least a portion of the payment to the one or more beneficiaries.
